(19) United States
(12) Patent Application Publication
(10) Pub. No.: US 2003/0023899 A1
(43) Pub. Date: Jan. 30, 2003

(54) Data compression/transmission and restoration methods using IPC in switching system

(75) Inventor: Tae-Yong Kim, Suwon (KR)

Correspondence Address: FLESHNER & KIM, LLP, P.O. Box 221200, Chantilly, VA, 20153-1200, US

(73) Assignee: LG Electronics Inc.

(21) Appl. No.: 10/191,442

(22) Filed: Jul. 10, 2002

(30) Foreign Application Priority Data
Jul. 25, 2001 (KR) 44703/2001

(51) Int. Cl. H02H 3/05

(52) U.S. Cl. 714/18

(57) ABSTRACT

In a switching system, a data compression/transmission and restoration method performed using an IPC (inter processor communication) checks whether received original data is repeated, provides a pertinent signal to the checked data, transmitting the signal, and restores the signal in a main processor. Data compression efficiency is improved by checking whether one byte of received data is repeated, providing a different signal according to the check result, and transmitting the resulting information through the IPC. In addition, load on the overall switching system is reduced in terms of data compression time and restoration time.

### BACKGROUND OF THE INVENTION

1. Field of the Invention

The present invention relates to switching in a communications system, and in particular to a system and method for performing data compression/transmission and restoration using, for example, an IPC (inter processor communication).

2. Background of the Related Art

A switching apparatus in a communication system performs mutual information exchange among subscribers using a subscriber (user) line or a trunk line. A switching apparatus in a local exchange mutually connects certain subscribers within the same subscriber area (the same central telephone exchange area). A switching apparatus in a tandem/toll exchange relays calls from a local exchange in one area to a local exchange in another area. A switching apparatus in a toll exchange relays a long-distance call, and one in a private branch exchange provides an extension call (local loop call) to a group of subscribers such as a company, a hotel, a factory, etc.

A communications switching apparatus generally includes a control unit and a switch unit. The control unit includes a processor and performs a switch unit control, various service controls and maintenance/repair, etc. by using switching operation programs.

FIG. 1 is a block diagram illustrating a construction of a general switching system. The system is constructed with an SMP (system management processor) 10, which functions as a loading server and performs maintaining/repairing operations, a MP (main processor) 20, which stores switching programs and controls a switch unit (not shown), and a disk 30 for storing data.

The SMP 10 is constructed with a packaging program 11 for compressing data, a memory 12 for storing the compressed data, and an SLH (system loading handler) 13 for reading data on disk 30 and performing a loading server function. In addition, the MP 20 includes a PLH (processor loading handler) 21 for transmitting a data reception signal and a loading request signal to the SMP 10, and the disk 30 includes a memory 31 for storing data. Typically, the switching system includes one SMP and a plurality of MPs and a disk. An MP is constructed with one pertinent to the SMP, and the rest of the MPs perform loading operation by communicating with the SMP connected to the disk through the IPC.

The SMP 10 and the MP 20 perform mutual communication by an IPC (inter processor communication) method, and the SMP 10 and the disk 30 perform mutual communication by a SCSI (small computer system interface).

An OS (operating system) provides the IPC function in order to make processors communicate with other processors. The IPC is a communication method among processors in the same system or among processors of other systems using a network. In the IPC, one application program can control another application program, and some application programs hold data jointly without interfering each other.

The SCSI (small computer system interface) method is a serial standard interface for connecting a computer to affiliates. It includes mechanical and electrical requests necessary for connecting to an I/O bus and an affiliates' central instruction set.

A general method for performing compression/transmission processes in the switching system will be described with reference to accompanying FIG. 1. In this method, the SMP 10 of the switching system receives a data reception request signal and sends a loading request signal from the PLH 21 of the MP 20 to SMP 10 through the IPC (inter processor communication). The SMP 10 receives the loading request signal and retrieves an original file from memory 31 of the disk 30 through the SCSI (small computer system interface) method. The SMP 10 compresses the received original file through the packaging program 11 and stores the compressed data in the memory 12 of the SMP 10. The memory 12 transmits the compressed file storing the compressed data to the MP 20 through the IPC.

FIG. 2 is a flow chart illustrating data compression/transmission methods in the switching system described above. In a first step, the packaging program 11 reads one byte of the compressed data of the received compressed file and stores it in a key, as shown at steps S20, S21. When the read value is stored in the key, the packaging program 11 reads the next one byte and checks to determine whether it is the same value as the stored value, as shown at steps S22, S23. When the two values are the same, the packaging program 11 increases a count as “1” and repeats the above-described steps as shown at steps S31˜S32. When the values are different from each other, the packaging program 11 stores the key value in the memory 12 of the SMP 10 and reads a count of the key value, as shown at steps S24, S25. After that, the packaging program 11 checks whether the count is “1” as shown at step S26.

When the count is “1”, the packaging program 11 checks whether the next one byte to be read exists, as shown at step S34. When the next byte to be read exists, the packaging program 11 reads the next one byte, stores it in the key, and repeats the above-described steps as shown at step S35. If the next one byte to be read does not exist, the packaging program 11 records/stores the read one byte in the memory 12 and finishes the compression, as shown at step S30.

When the count is not “1”, the packaging program 11 records/stores a “144” reporting repetition of a previous recorded/stored byte and the count of the key value in the memory 12 as shown at steps S27, S28. When the recording/storing is finished, the packaging program 11 checks whether a next byte to be read exists as shown at step S29. In the check result, when the next byte to be read exists, the packaging program 11 reads the next byte to be read, stores it in a key, and repeats the above-described steps as shown at step S33. However, when a next byte to be read does not exist, the packaging program 11 records/stores one byte read in a previous step in the memory 12 and finishes the compression as shown at step S30.

General compression/transmission methods in the switching system will be described with reference to accompanying FIGS. 3 and 4. More specifically, compressing/transmitting data “00/00/00/FF/00” stored in the original file of FIG. 3 by using the packaging program 11 of the SMP 10 will be described.

FIG. 3 illustrates the original data stored in the memory 31 of the disk 30, and FIG. 4 illustrates data compressed by the conventional method. In operation, the packaging program 11 of the switching system reads “00” as one byte of the original data stored in the memory 12 of the SMP 10 and stores it in a key. The packaging program 11 reads “00” as next one byte and checks whether the read value “00” and the key-stored value “00” are the same. If they are the same, the packaging program 11 increases a count about the key value as “1”. Accordingly, the count about the key value is “02”.

When the count is increased as “1”, the packaging program 11 checks whether a next byte to be read exists. If in a next byte to be read “00” exists, the packaging program 11 reads the next one byte “00” and checks whether the read value and the value stored in the key are the same. Here, the read value “00” and the key-stored value “00” are the same. Therefore, packaging program 11 increases the count for the key-stored value by “1”. Accordingly, the count about the key value is “03”. When the count is increased by “1”, the packaging program 11 checks whether a next byte to be read exists. If a next byte to be read “FF” exists, the packaging program 11 reads the next one byte “FF”. The packaging program 11 checks whether the read one byte and the key value are the same. Here, the read one byte “FF” and the key value “00” arc different from each other. Consequently, the key value “00” is recorded/stored in the memory 12 of the SMP 10.

After these steps, the packaging program 11 reads the count of the key value and checks whether the read count is “1”. Because the read count is “03”, the packaging program 11 records/stores a “144” reporting repetition of the one byte and the count “03”. When the recording/storing is finished, the packaging program 11 checks whether a next byte to be read exists. If a next byte to be read “FF” exists, the packaging program 11 stores the last read value “FF” in the key and reads next one byte “00”. When the “00” is read, the packaging program 11 checks whether the read value and the key value are the same. Here, the read value “00” and the key-stored value “FF” are different from each other. The packaging program 11 therefore records/stores the key value “FF” in the memory 12. When the value is recorded/stored, the packaging program 11 checks whether a next byte to be read exists and repeats the above-described process.

The compressed data passing the above-described process is “00/144/03/FF/00”. When 32 byte original data of the original file of FIG. 3 is compressed, as depicted in FIG. 4, it is compressed to 24 bytes, thereby achieving a compression efficiency of 25%.

Transmitting/restoring the compressed data in the switching system will be described with reference to FIG. 5. Here, the MP 20 receives the compressed data of the file from the SMP 10 through the IPC and transmits it to the PLH 21. PLH 21 reads one byte of the received data and stores it in the key as shown at steps S50, S51. When the storing is finished, the PLH 21 reads next one byte and checks whether it is a “144” reporting repetition of the read value as shown at steps S52, S53.

When the read value is “144”, the PLH 21 reads next one byte, namely, one byte reporting the number of repetition times of the key value, stores it in the key and stores the read value in the count as shown at steps S54˜S56. The PLH 21 reads a key value and the count value stored previous to “144”, repeats the key value as same as the count and records/stores it in the PLH 21 as shown at step S57. The PLH 21 repeatedly records/stores the value and checks whether the next one byte to be read exists as shown at step S58. However, when the read value is not “144”, the PLH 21 stores the key value and repeats the above-described process as shown at step S59.

When next one byte to be read does not exist, the PLH 21 finishes restoring the compressed data. However, when next one byte to be read exists, the PLH 21 reads the next one byte, stores it in the key and checks whether a next byte to be read exists as shown at steps S60, S61. When next one byte to be read exists, the PLH 21 reads the next byte, stores it in the key and repeats the above-described process as shown at step S52. However, when next one byte to be read does not exist, the PLH 21 records/stores the key value and finishes restoring the compressed data as shown at step S63.

Restoring the data “00/144/03/FF/00” stored in the compressed file of FIG. 4 in the PLH 21 will be described in detail with reference to accompanying FIGS. 3 and 4. Here, when the PLH 21 of the switching system receives the compressed data of the compressed file from the SMP 10, a memory area is formed inside the PLH 21. When the memory area is formed, the PLH 21 reads one byte “00” of the received data and stores it in the key. When the key value is stored, the PLH 21 reads the next one byte “144” and checks whether the read value is a “144” reporting repetition of a previous read byte.

If the read value is “144”, the PLH 21 reads a next byte “03” and stores it in the key and the count. The read “03” means the number of repetition times of “00” read previous to “144”. When the storing is finished, the PLH 21 records/stores “00” read previous to “144” as same as the count “03”. Accordingly, the value recorded in the PLH 21 is “00/00/00”. When the recording/storing is finished, the PLH 21 checks whether a next byte to be read exists.

If a next byte to be read “FF” exists, the PLH 21 reads the next one byte “FF”, stores it in the key and checks whether a next byte to be read exists. If a next byte to be read “00” exists, the PLH 21 reads the next one byte “00” and checks whether the read value is “144”. In the check result, because the read value is not “144”, the PLH 21 records the key value and checks whether a next byte to be read exists. If a next byte to be read does not exist, the restoring process of the PLH 21 is finished.

In the conventional compression/transmission and restoration methods, which use the IPC in the switching system, because a separator for separating data into the number of repetition times and real data is used, a compression efficiency is lowered. In addition, because several steps of transmitting a loading request signal from the SMP 10 to the MP 20, reading data from the disk 30, compressing/restoring the data, storing it in the memory 12 of the SMP 10 and transmitting the compressed or restored data to the MP 20 have to be performed, compressing and restoring time takes a long time. Accordingly a load of a pertinent processor increases.

The above references are incorporated by reference herein where appropriate for appropriate teachings of additional or alternative details, features and/or technical background.

### SUMMARY OF THE INVENTION

It is an object of the present invention to provide a data compression/transmission and/or restoration method using an IPC in a switching system, and more specifically one capable of improving data compression efficiency by checking whether one byte of received data is repeated, providing a different signal according to the check result and transmitting the resulting information through the IPC. This method decreases a load on overall switching system by reducing data compression time and restoration time. In accordance with one embodiment, the data compression/transmission and restoration method of the present invention checks whether received original data is repeated, provides a pertinent signal to the checked data, transmits it and restores the signal in a MP (main processor).

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a block diagram illustrating a general switching system;

FIG. 2 is a flow chart illustrating a data compression method in a general switching system;

FIG. 3 illustrates the original data;

FIG. 4 illustrates data compressed through the general switching system;

FIG. 5 is a flow chart illustrating a method for restoring compressed data in the general switching system;

FIGS. 6A and 6B are flow charts illustrating data compression/restoration methods in a switching system in accordance with the present invention;

FIG. 7 is a flow chart illustrating a method for restoring compressed data in the switching system in accordance with the present invention;

FIG. 8 illustrates data compressed by a compression method in accordance with the present invention;

FIG. 9A is a format view illustrating a PackedData signal in accordance with the present invention; and

FIG. 9B is a format view illustrating a PlainData signal in accordance with the present invention.

### DETAILED DESCRIPTION OF PREFERRED EMBODIMENTS

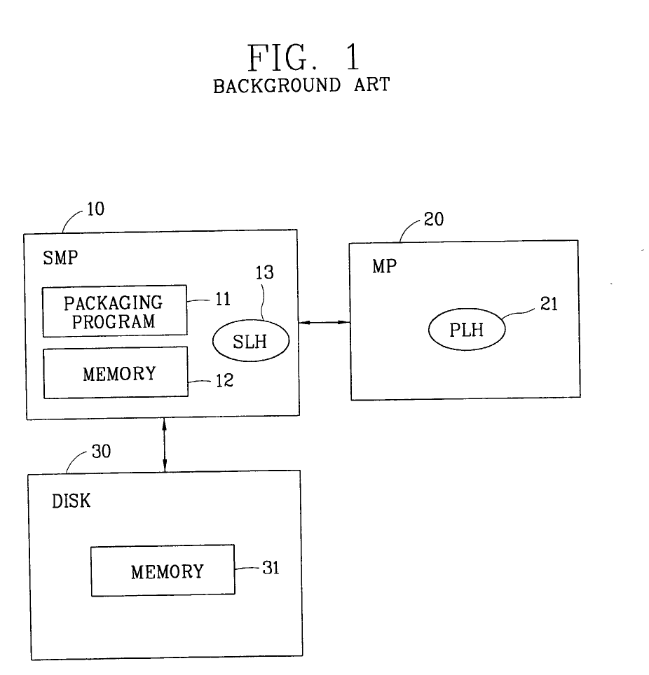

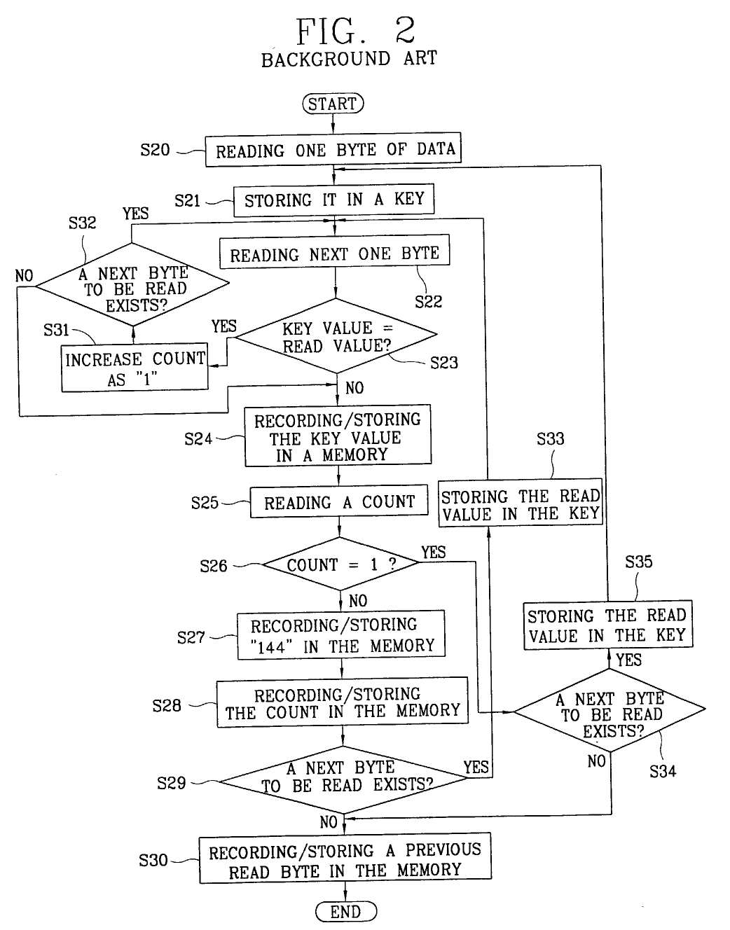

A data compression/transmission method in a switching system in accordance with an embodiment of the present invention will be described with reference to accompanying FIG. 1. The present invention, includes the same SMP 10, which receives original data from an original file from memory 31 of disk 30 by receiving a data reception request signal and a loading request signal from PLH 22 of MP 20 as in the conventional art.

The SMP 10 transmits the received original data to the packaging program 11. The packaging program 11 checks whether it is repeated or not by reading the received original data by one byte, and transmits the read one byte and repeated count to an OS (not shown) of the switching system. The OS classifies the received one byte and the count, provides a PlainData signal to the one byte and a PackedData signal to the count reporting the number of repetition times of a previous byte and transmits them to an IPC F/W (not shown). The IPC F/W (not shown) classifies the PlainData signal and the PackedData signal by an ATM cell and transmits them to the MP 20.

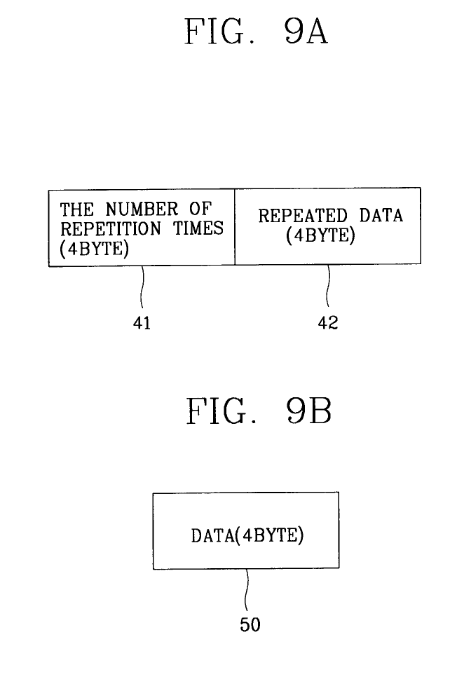

As depicted in FIG. 9A, the PackedData signal may be constructed with a total of 8 bytes. 4 bytes store the number of repetition times 41 and 4 bytes store the repeated data 42. The PackedData signal stores/transmits compressed data and the number of repetition times of the compressed data. Accordingly, the compressed data can be decoded normally. In addition, as depicted in FIG. 9B, the PackedData signal constructed with the total 4 bytes stores/transmits non-compressed data.

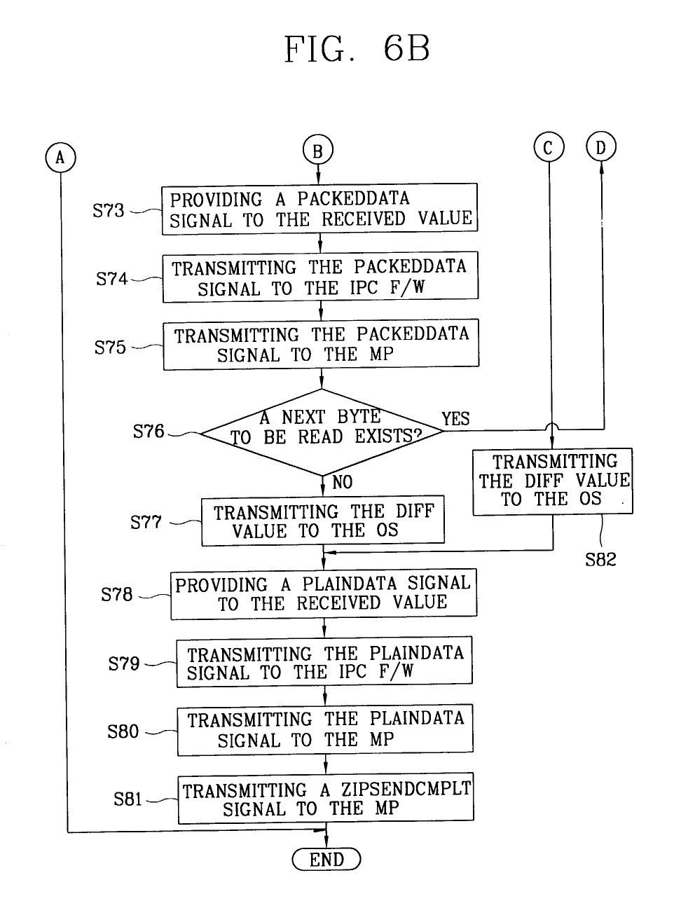

A data compression/transmission method in accordance with an embodiment of the present invention will now be described with reference to FIGS. 6A and 6B. Here, packaging program 11 reads one byte of the received original data, stores it in the key and transmits it to the OS (not shown) as shown at steps S60˜S62. The OS determines that the received key value is plain data, provides a PlainData signal to the data and transmits it to the IPC F/W (not shown) as shown at steps S63˜S64. The IPC/F/W senses the signal received through the ATM cell is the PlainData signal and transmits it to the MP 20 as shown at step S65.

When the signal is received, the packaging program 11 reads a next byte, stores it in a diff and checks whether the key value and the diff value are the same as shown at steps S66˜S68. When the two values are the same, the packaging program 11 increases a count about the key value as “1”, checks whether a next data to be read exists, and repeats the above-described steps as shown at steps S69 and S70. However, when the two values are different from each other, the packaging program 11 checks whether the count corresponding to the key value is “01,”, as shown at step S71. When the count is “01”, the packaging program 11 transmits the diff-stored value to the OS as shown at step S82. The OS detects that the received key value is plain data, provides a PlainData signal to the data, and transmits it to the IPC F/W (not shown) as shown at steps S77˜S79. The IPC/F/W detects that the signal received through the ATM cell is the PlainData signal and transmits it to the MP 20 as shown at step S80.

When the count is not “01”, the packaging program 11 transmits the count to the OS as shown at step S72. The OS detects that the received key value is plain data, provides a PackedData signal to the data, and transmits it to the IPC F/W (not shown) as shown at steps S73, S74. The IPC F/W detects that the signal received through the ATM cell is a PackedData signal and transmits it to the MP 20.

When the signal is transmitted, the Packaging program 11 checks whether a next byte to be read exists as shown at step S76. In the check result, when a next byte to be read exists, the packaging program 11 reads a next byte, stores it in the key and repeats the above-described steps as shown at step S83.

When a next byte to be read does not exist, the packaging program 11 transmits the diff-stored value to the OS as shown at step S77. The OS detects that the received value is plain data, provides a PackedData signal to the data, and provides it to the IPC F/W (not shown) as shown at steps S78˜S79. The IPC F/W detects that the signal received through the ATM cell is the PackedData signal, and transmits it to the MP 20 as shown at step S80. After that, the packaging program 11 transmits a ZipSendCmplt signal reporting compression end to the MP 20 and finishes the compression as shown at step S81.

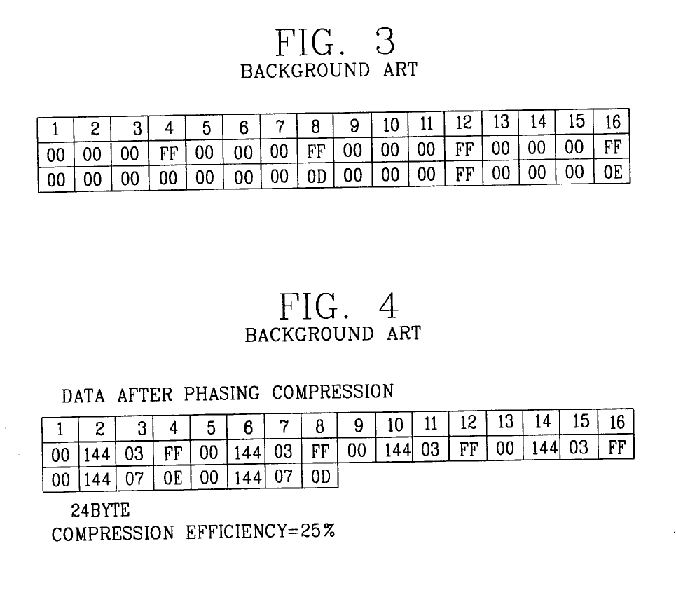

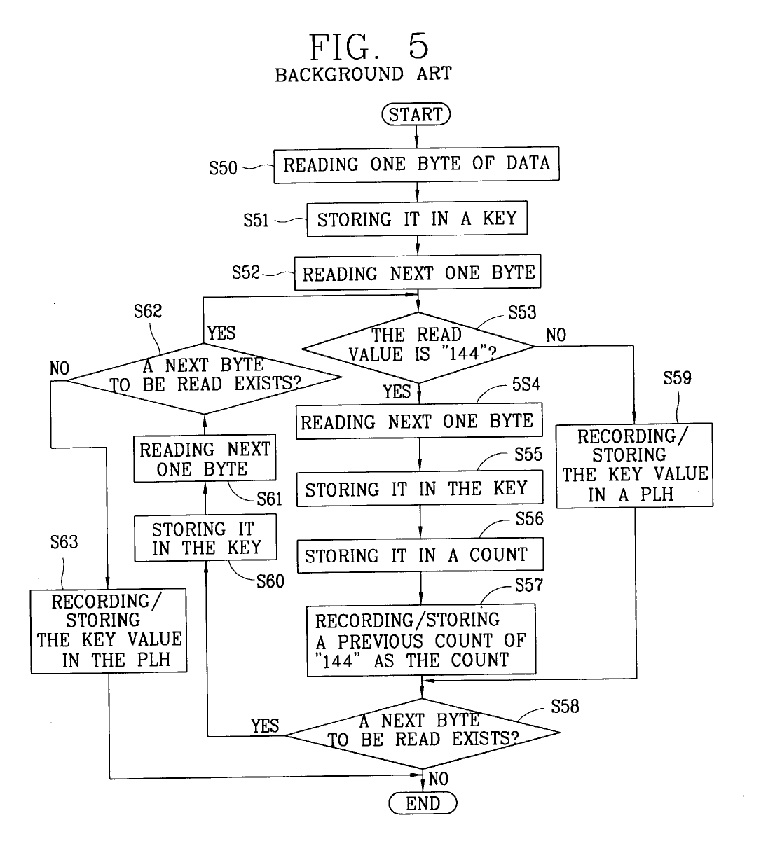

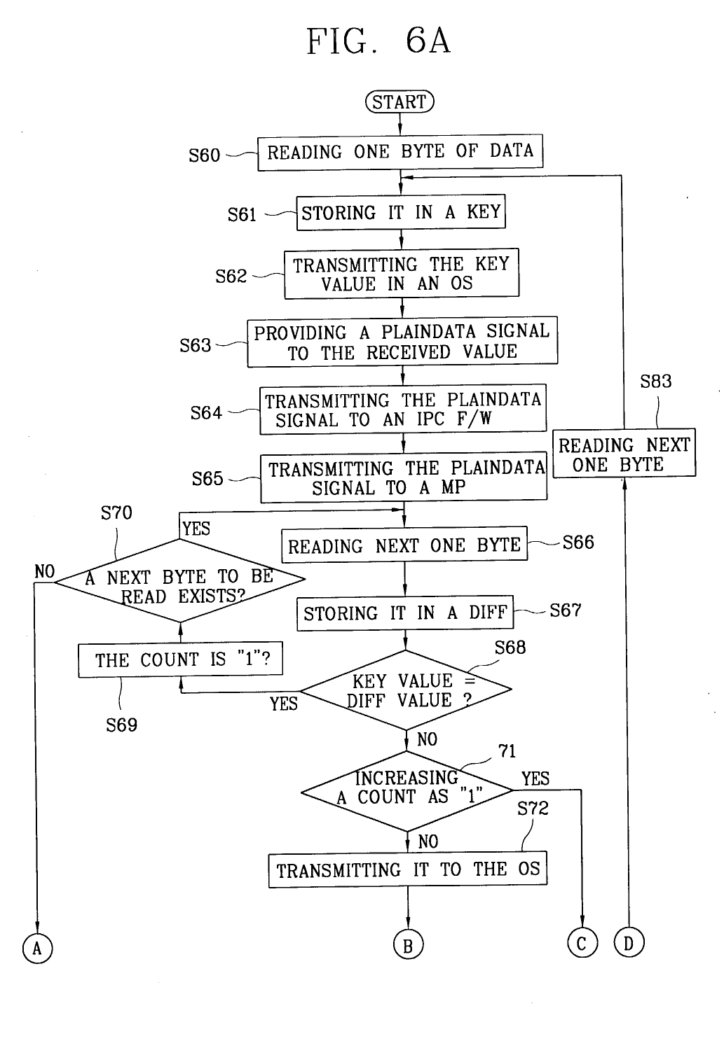

Compressing data “00/00/00/FF/00” stored in the original file of FIG. 4 through the packaging program 11 of the SMP 10 will be described in more detail with reference to FIGS. 3 and 4. To perform this compression, the packaging program 11 reads one byte “00” of the received original data, stores it in the key, and transmits it to the OS of the switching system. The OS detects that the received one byte “00” is plain data, provides a PlainData signal to the data, and transmits it to the IPC F/W. The IPC F/W detects that the signal received through the ATM cell is the PlainData signal and transmits it to the MP 20.

The packaging program 11 transmits the one byte stored in the key to the OS, reads the next one byte “00”, stores it in the diff, and checks whether the key value and the diff value are the same. If the diff value “00” and the key value “00” are the same, the packaging program 11 increases the count about the key value as “01”. Accordingly, the count about the key value is “02”.

When the count is increased, the packaging program 11 checks whether a next byte to be read exists. If a next byte to be read “00” exists, the packaging program 11 reads a next byte “00”, stores it in the diff, and checks the diff value and the key value are the same. If they are the same, the packaging program 11 increases a count about the key value as “01”. Accordingly, the count about the key value is “03”.

When the count is increased, the packaging program 11 checks whether a next byte to be read exists. If a next byte to be read is “FF”, the packaging program 11 reads the next byte “FF”, stores it in the diff, and checks whether the diff value and the key value are the same. If the diff value “FF” and the key value “00” are different from each other, the packaging program 11 checks whether the count about the key value is “01”. If the count about the key value is “03”, the packaging program 11 transmits the count “03” to the OS. The OS detects that the received “03” is count, provides a PackedData signal to the “03”, and transmits it to the IPC F/W. The IPC F/W detects that the signal received through the ATM cell is the PackedData signal and transmits it to the MP 20.

The packaging program 11 checks whether a next byte to be read exists. In the check result, a next byte to be read “00” exists, the packaging program 11 stores the diff-stored “FF” in the key and transmits the stored value to the OS (not shown) of the switching system. The OS detects that the received one byte “FF” is plain data, provides a PlainData signal to the data, and transmits it to the IPC F/W. The IPC F/W detects the signal received through the ATM cell is the PlainData Signal and transmits it to the MP 20.

Next, the packaging program 11 checks whether a next byte to be read exists. If the next byte to be read “00” exists, the packaging program 11 reads the next byte “00”, stores it in the diff, and checks whether the diff value and the key value are the same. If they are different each other, the packaging program 11 checks whether the count about the key value is “01”. If the count is “01”, the packaging program 11 transmits the diff-stored one byte “00” to the OS. The OS detects that the received “00” is plain data, provides a PlainData signal to the data and transmits it to the IPC F/W. The IPC F/W detects that the signal received through the ATM cell is a PlainData signal, and transmits it to the MP 20.

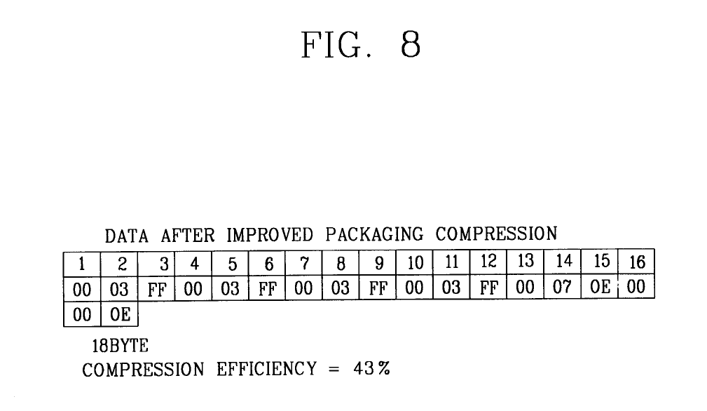

When the transmission is finished, the packaging program 11 checks whether a next byte to be read exists. However, if a next byte to be read does not exist, the packaging program 11 finishes compression of the data. Accordingly, the SMP 10 transmits the “00” PlainData signal, the “03” PlainData signal, the “FF” PlainData signal and the “00” PlainData signal to the MP 20. The original data “00/00/00/FF/00” is compressed as “00/03/FF/00” by the above-described compression method. The 32 byte original file of FIG. 3 is compressed as 18 byte as shown at FIG. 8, accordingly its compression efficiency is 43%.

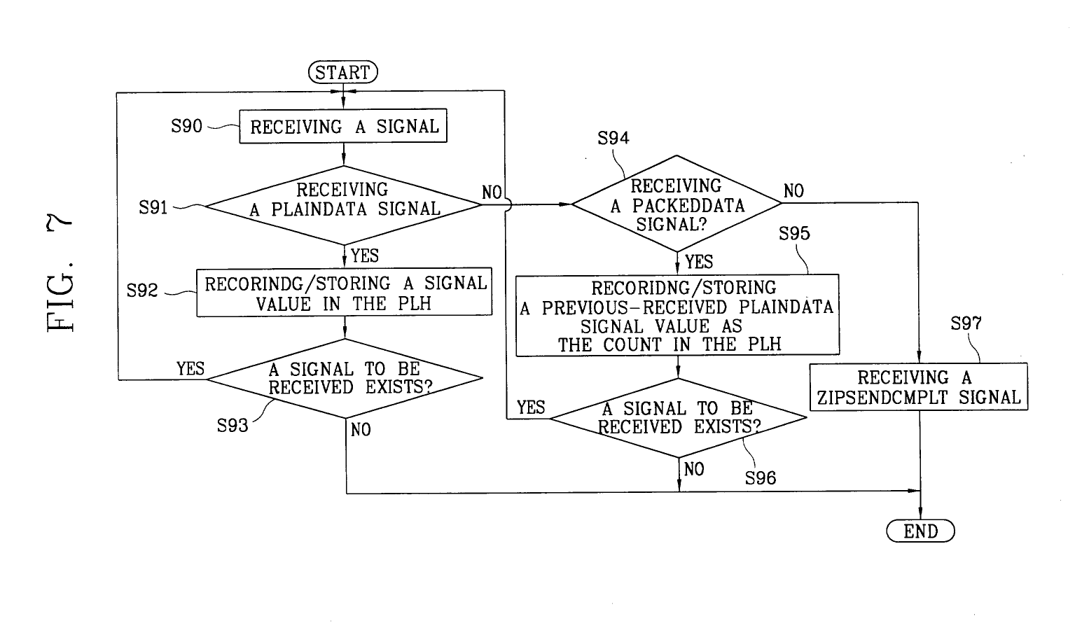

A method for restoring a signal having compressed data received in the MP 20 will now be described with reference to FIG. 7. In this method, MP 20 receives the signal having compressed data from the SMP 10 through the IPC and transmits it to the PLH 21. The PLH 21 forms an inside memory area (not shown) for storing the data of the received signal. Then, the PLH 21 checks whether the received signal is a PlainData signal as shown at steps S90, S91. When the received signal is a PlainData signal, the PLH 21 records/stores one byte of the PlainData signal as shown at step S92. When the storing is finished, the PLH 21 checks whether a received signal exists as shown at step S93. When a received signal exists, the above-described steps are repeated, and when a received signal does not exist, the storing is finished.

When the received signal is not a PlainData signal, the PLH 21 checks whether the received signal is a PackedData signal as shown at step S94. When the received signal is a PackedData signal, the PLH 21 repeatedly records/stores one byte of a previously stored PlainData signal as the number of times, subtracting 1 from the count of the PackedData signal. This is because the one byte of the PackedData signal means the number of repetition times of the previous stored PlainData signal.

When the recording/storing are finished, the PLH 21 checks whether a signal to be received exists as shown at step S96. When a signal to be received exists, the PLH 21 receives a signal and repeats the above-described steps. When a signal to be received does not exist, the restoring is finished.

When a received signal is neither a PlainData signal nor a PackedData signal, the received signal is a ZipSendCmplt signal reporting data compression end. The PLH 21 receives the ZipSendCmplt signal and finishes the restoring as shown at step S97.

A compressed data restoration method in accordance with the present invention will now be described with reference to FIGS. 38. A process for restoring compressed data “00/03/FF/00” of FIG. 8, namely, restoring a “00” PlainData signal, a “03” PackedData signal, a “FF” PlainData signal and a “00” PlainData signal in the MP 20 will be described in detail.

In this method, MP 10 serially receives a “00” PlainData signal, a “03” PackedData signal, an “FF” PlainData signal, and a “00” PlainData signal, and transmits them to the PLH 21. After receiving the signals, the PLH 21 forms a memory area (not shown) and checks whether the received signal is a PlainData signal. If the received signal is a PlainData signal, the PLH 21 records/stores “00” of the PlainData signal in the memory area (not shown).

When the recording/storing is finished, the PLH 21 checks whether a next signal to be received exists. If a next signal to be received exists, the PLH 21 receives the signal and checks whether the received signal is a PlainData signal. Here, because the received signal is a PlainData signal, the PLH 21 records/stores a previous recorded/stored “00” as “02”, subtracting 1 from the count “03” of the PackedData signal. Accordingly, “00/00/00” is recorded/stored in the memory (not shown).

When the recording/storing is finished, the PLH 21 checks whether a next signal to be received exists. If a next signal to be received exists, the PLH 21 receives the signal and checks whether the received signal is a PlainData signal. If the received signal is a PlainData signal, the PLH 21 stores “FF” of the PlainData signal in the memory and checks whether a next signal to be received exists. If a PlainData signal exists, the PLH 21 stores “00” of the received PlainData signal in the memory (not shown) and checks whether a next signal to be received exists. If a next signal to be received as a ZipSendCmplt signal exists, the PLH 21 receives the signal. Because the received signal is neither a PlainData signal nor a PackedData signal but a ZipSendCmplt signal reporting a data compression end, the PLH 21 finishes restoring the compressed data. Accordingly, restored 4 byte as “00/00/00/FF/00” is recorded/stored in the memory of the PLH 21.

The present invention therefore improves a compression efficiency by compressing original data in a switching system, classifying kinds of signal by plain/repeated data in transmission and restoring compressed data according to the classified signal kind. In addition, it is also possible to reduce the processing time and overall load of the switching system by reading/compressing data of the original file and transmitting it directly to the MP 20 without storing it in the memory of the SMP 10. Accordingly, a reliability and stability of the switching system can be improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A data compression/transmission and restoration method using an inter processor communication (IPC) in a switching system, comprising:
checking whether original data is repeated;
transmitting a compressed version of the original data with a signal indicative of whether the data checked in the checking step is repeated; and
restoring the original data in a main processor (MP) based on said signal.

2. The method of claim 1, wherein the checking step includes:
transmitting the original data from a system management processor (SMP) to a packaging program;
reading one byte of the received original data and checking whether the read one byte is repeated; and
transmitting the one byte to an operating system (OS) when the one byte is not a repeated one.

3. The method of claim 2, wherein the SMP transmits a number of repetition times of the one byte to the OS when the one byte is repeated in the checking step.

4. The method of claim 1, wherein the transmitting step includes:
checking a kind of the one byte received in the OS; and
providing a PlainData signal to the one byte when the one byte is not repeated in a said step, and transmitting the one byte to an IPC F/W.

5. The method of claim 4, wherein the OS includes a PackedData signal with a count, and wherein the count reports a number of repetition times of the received one byte, and transmits it to the IPC F/W.

6. The method of claim 2, wherein the SMP transmits a ZipSendCmnplt signal to the MP through the IPC when the original data to be compressed does not exist.

7. The method of claim 5, wherein the IPC F/W classifies kinds of received signals by using an asynchronous transfer mode (ATM) cell.

8. The method of claim 5, wherein the IPC F/W classifies a kind of a received signal and transmits the received signal to the MP.

9. The method of claim 1, wherein the storing step includes:
transmitting the signal received in the MP to a processor loading handler (PLH);
checking a kind of the received signal by the PLH; and
recording/storing one byte of the received signal in a memory space according to a result of said kind-checking step.

10. The method of claim 9, wherein the PLH forms an inside memory space when one byte of the signal is received.

11. The method of claim 9, wherein the PLH stores one byte of a PlainData signal in the memory space when the received signal is the PlainData signal.

12. The method of claim 9, wherein the PLH stores a previous recorded/stored one byte in the memory space as a number of times, subtracting 1 from a counter of a PackedData signal when the received signal is the PackedData signal.

13. The method of claim 9, wherein the PLH finishes restoring compression of data when the received signal is a ZipSendCmplt signal.

14. A data compression/transmission and restoration method using an inter process communication (IPC) in a switching system, comprising:
reading one byte of the original data;
checking whether the read one byte is repeated using a packaging program;
providing a PlainData signal to the one byte when the one byte is determined not to be repeated in the checking step;
transmitting said signal to a main processor (NP); and
receiving and restoring the signal in the MP.

15. The method of claim 14, wherein the packaging program transmits the number of repetition times to an operating system (OS) when the read one byte is a repeated one.

16. The method of claim 15, wherein the OS checks the received one byte to determine a counter reporting a number of repetition times of a previously received one byte, provides a PackedData signal to the received one byte, and transmits the byte to an IPC F/W.

17. The method of claim 16, wherein the IPC F/W classifies a kind of the received signal and transmits it to the MP.

18. The method of claim 16, wherein the IPC F/W classifies the kind of the received signal using an asynchronous transfer mode (ATM) cell.

19. The method of claim 14, wherein the transmitting step includes:
transmitting the read one byte to the OS after checking that the read one byte is not a repeated one;
checking whether a received one byte has a count;
providing a PlainData signal to the one byte when the one byte does not have a count in the check result; transmitting the signal to the IPC F/W;
checking a kind of the signal received in the IPC F/W; and
checking whether the received signal is a PlainData signal and transmitting the PlainData signal to the MP.

20. The method of claim 19, wherein the IPC F/W classifies the kind of the received signal using the ATM cell.

21. The method of claim 14, wherein the restoring step includes:
checking a kind of a signal received in the processor loading handler (PLH); and
recording/storing one byte of the signal when the received signal is a PlainData signal.

22. The method of claim 21, wherein the PLH forms an inside memory space when the signal is received.

23. The method of claim 21, wherein the PLH records/stores a previous recorded/stored one byte as the number of times subtracting 1 from a count of a PackedData signal when it receives the PackedData signal.

24. The method of claim 21, wherein the PLH finishes a restoring operation when it receives a ZipSendCmplt signal from the SMP.

25. The method of claim 24, wherein the SMP transmits a ZipSendCmplt signal to the MP when compression of the received original data is finished.

26. A method for transmitting data in a communication system, comprising:
determining whether at least one portion of original data is repeated;
compressing the original data; and
transmitting the compressed data with a signal indicative of whether a portion of the compressed data is repeated.

27. A system for transmitting data in a communication system, comprising:
a checking unit which determines whether at least one portion of original data is repeated;
a compression unit which compresses the original data; and
a transmitter which transmits the compressed data with a signal indicative of whether a portion of the compressed data is repeated.

28. A method for restoring compressed data in a communication system, comprising:
determining whether compressed data includes information indicative of whether a portion of the compressed data repeats; and
restoring original data from the compressed data based on said information.

29. A system for restoring compressed data in a communication system, comprising:
a detection unit which determines whether compressed data includes information indicative of whether a portion of the compressed data repeats; and
a processor which restores original data from the compressed data based on said information.
